(19) United States
(12) Patent Application Publication
(10) Pub. No.: US 2023/0379032 A1
(43) Pub. Date: Nov. 23, 2023

(54) TRIGGERING APERIODIC CHANNEL STATE INFORMATION REPORTING

(71) Applicant: Telefonaktiebolaget LM Ericsson (PUBL), Stockholm (SE)

(72) Inventors: Yufei Blankenship, KILDEER, IL (US); Zhipeng Lin, NANJING Jiangsu (CN); Shiwei Gao, NEPEAN (CA); Siva Muruganathan, STITTSVILLE (CA); Jonas Fröberg Olsson, LJUNGSBRO (SE); Robert Mark Harrison, GRAPEVINE, TX (US)

(21) Appl. No.: 18/248,719

(22) PCT Filed: Oct. 12, 2021
(86) PCT No.: PCT/IB2021/059368

§ 371 Date: Apr. 12, 2023

(30) Foreign Application Priority Data
Oct. 12, 2020 (WO) PCT/CN2020/120506

(51) Int. Cl. H04B 7/06; H04W 72/232

(52) U.S. Cl. CPC H04B 7/0626; H04W 72/232

(57) ABSTRACT

According to some embodiments, a method implemented by a network node in a communication network for obtaining channel state information (CSI) comprises generating a downlink control information (DCI) to trigger an aperiodic CSI (A-CSI) reporting via a physical uplink control channel (PUCCH) and transmitting the DCI to a terminal device to initiate A-CSI reporting on the PUCCH.

### TECHNICAL FIELD

The present disclosure generally relates to the field of wireless communications, and more specifically to obtaining channel state information (CSI).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

This section introduces aspects that may facilitate better understanding of the present disclosure. Accordingly, the statements of this section are to be read in this light and are not to be understood as admissions about what is in the prior art or what is not in the prior art.

Third Generation Partnership Project (3GPP) wireless specifications include fifth generation (5G) new radio (NR). NR uses cyclic prefix orthogonal frequency division multiplexing (CP-OFDM) in both downlink (DL) (i.e., from a network node, gNB or base station to a user equipment or UE) and uplink (UL) (i.e., from UE to gNB). Discrete Fourier transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically on a slot basis, an example of which is shown in FIG. 1 with a 14-symbol slot, where the first two symbols contain physical downlink control channel (PDCCH) and the rest contains physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×2^{μ}) kHz where μ∈{0,1,2,3,4}. Δf=15 kHz is the basic subcarrier spacing. The slot durations at different subcarrier spacings are given by ½^{μ} ms.

171 In the frequency domain, a system bandwidth is divided into resource blocks (RBs), each of which corresponds to 12 contiguous subcarriers. The RBs are numbered starting with 0 from one end of the system bandwidth. A basic NR physical time-frequency resource grid is illustrated in FIG. 2, where only one resource block (RB) within a 14-symbol slot is shown. One OFDM subcarrier during one OFDM symbol interval forms one resource element (RE).

Downlink and uplink data transmissions can be either dynamically or semi-persistently scheduled by a gNB. In the case of dynamic scheduling, the gNB may transmit, in a downlink slot, downlink control information (DCI) to a UE on physical downlink control channel (PDCCH) about data carried on PDSCH to the UE and/or data on PUSCH to be transmitted by the UE. In the case of semi-persistent scheduling, periodic data transmission in certain slots can be configured and activated/deactivated.

For each transport block data transmitted over PDSCH, a hybrid automatic repeat request acknowledgement (HARQ-ACK) is sent in a UL PUCCH depending on whether it is successfully decoded or not. An ACK is sent if it is successfully decoded and a NACK is sent otherwise.

PUCCH can also carry other UL control information (UCI) such as scheduling request (SR) and DL channel state information (CSI).

There are three DCI formats defined for scheduling PDSCH in NR, i.e., DCI format 1_0 and DCI format 1_1 which were introduced in NR Rel-15, and DCI format 1_2 which was introduced in NR Rel-16. DCI format 1_0 has a smaller size than DCI 1_1 and can be used when a UE is not fully connected to the network while DCI format 1_1 can be used for scheduling MIMO (Multiple-Input-Multiple-Output) transmissions with multiple MIMO layers.

In NR Rel-16, DCI format 1_2 was introduced for downlink scheduling. One of main motivations for having the new DCI format is to be able to configure a very small DCI size which can provide some reliability improvement without losing much flexibility. A main design target of the new DCI format is thus to have DCI with configurable sizes for some fields with a minimum DCI size targeting a reduction of 10-16 bits relative to Rel-15 DCI format 1_0.

When receiving PDSCH in the downlink from a serving gNB at slot n, a UE feeds back a HARQ ACK at slot n+k over a PUCCH resource in the uplink to the gNB if the PDSCH is successfully decoded, or otherwise, the UE sends a HARQ ACK/NACK at slot n+k to the gNB to indicate that the PDSCH is not successfully decoded. If two transport blocks (TBs) are carried by the PDSCH, then a HARQ ACK/NACK is reported for each TB.

For DCI format 1_0, k is indicated by a 3-bit PDSCH-to-HARQ-timing-indicator field. For DCI formats 1_1 and 1_2, k is indicated either by a 0-3 bit PDSCH-to-HARQ-timing-indicator field, if present, or by higher layer configuration through radio resource control (RRC) signaling. Separate RRC configuration of PDSCH to HARQ-ACK timing is used for DCI formats 1_1 and 1_2.

For DCI format 1_1, if code block group (CBG) transmission is configured, a HARQ ACK/NACK for each CBG in a TB is reported instead.

For carrier aggregation (CA) with multiple carriers and/or TDD operation, multiple aggregated HARQ ACK/NACK bits need to be sent in a single PUCCH.

In NR, up to four PUCCH resource sets can be configured to a UE. A PUCCH resource set with pucch-ResourceSetId=0 can have up to 32 PUCCH resources while for PUCCH resource sets with pucch-ResourceSetId=1 to 3, each set can have up to 8 PUCCH resources. A UE determines the PUCCH resource set in a slot based on the number of aggregated uplink control information (UCI) bits to be sent in the slot. The UCI bits consist of HARQ ACK/NACK, scheduling request (SR), and channel state information (CSI) bits.

A 3-bit PUCCH resource indicator (PM) field in DCI maps to a PUCCH resource in a set of PUCCH resources with a maximum of eight PUCCH resources. For the first set of PUCCH resources with pucch-ResourceSetId=0 and when the number of PUCCH resources, R_{PUCCH}, in the set is larger than eight, the UE determines a PUCCH resource with index r_{PUCCH}, 0≤r_{PUCCH}≤R_{PUCCH}−1, for carrying HARQ-ACK information in response to detecting a last DCI format 1_0 or DCI format 1_1 in a PDCCH reception, among DCI formats 1_0 or DCI formats 1_1 the UE received with a value of the PDSCH-to-HARQ feedback timing indicator field indicating a same slot for the PUCCH transmission, as

$${r}_{PUCCH} = \{ \begin{matrix}\begin{matrix}⌊ \frac{{n}_{CCE , p} \cdot ⌈ {R}_{PUCCH} / 8 ⌉}{{N}_{CCE , p}} ⌋ + \\ {Δ}_{PRI} \cdot ⌈ \frac{{R}_{PUCCH}}{8} ⌉\end{matrix} & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot \\ ⌊ \frac{{R}_{PUCCH}}{8} ⌋ + {R}_{PUCCH} mod 8\end{matrix} & if {Δ}_{PRI} \geq {R}_{PUCCH} mod 8\end{matrix} \}$$

where Δf_{CCE,p} is the number of CCEs in CORESET p of the PDCCH reception for the DCI format 1_0 or DCI format 1_1, n_{CCE,p} is the index of a first CCE for the PDCCH reception, and Δ_{PRI} is a value of the PUCCH resource indicator field in the DCI format 1_0 or DCI format 1_1.

For UEs in random access procedures, Msg4 PDSCH transmission or MsgB PDSCH transmission will be followed by an ACK transmission on PUCCH if the PDSCH is correctly decoded, where the PUCCH resource is determined in the following ways depending on whether a 4-step random access channel (RACH) and/or a 2-step RACH is selected.

During the 4-step random access procedure, in response to the PDSCH reception with the UE contention resolution identity, the UE transmits HARQ-ACK information in a PUCCH. The PUCCH transmission is within the same active UL bandwidth part (BWP) as the PUSCH transmission scheduled by a random access response (RAR) UL grant. The PUCCH resource and the slot are determined by a 3-bit “PUCCH resource indicator” field and a 3-bit “PDSCH-to-HARQ feedback timing indicator” field respectively provided in DCI 1_0 with CRC scrambled by TC-RNTI.

A minimum time between the last symbol of the PDSCH reception and the first symbol of the corresponding PUCCH transmission with the HARQ-ACK information is equal to N_{T,1}+0.5 msec. N_{T,1} is a time duration of N₁ symbols corresponding to a PDSCH processing time for UE processing capability 1 when additional PDSCH DM-RS is configured. For μ=0 the UE assumes N_{1,0}=14.

During the 2-step random access procedure, the UE will trigger a transmission of a PUCCH with HARQ-ACK information having an ACK value if the RAR message(s) (MsgB) is for successRAR, where a PUCCH resource for the transmission of the PUCCH is indicated by a PUCCH resource indicator field of 4 bits in the successRAR from a PUCCH resource set that is provided by pucch-ResourceCommon, and a slot for the PUCCH transmission is indicated by a HARQ Feedback Timing Indicator field of 3 bits in the successRAR having a value k from {1, 2, 3, 4, 5, 6, 7, 8} and, with reference to slots for PUCCH transmission having duration T slot, the slot is determined as n+k+Δ, where n is a slot of the PDSCH reception and Δ is as defined for PUSCH transmission in Table 6.1.2.1.1-5 in 3GPP TS 38.214 V16.2.0.

The UE does not expect the first symbol of the PUCCH transmission to be after the last symbol of the PDSCH reception by a time smaller than N_(T,1)+0.5 msec where N_(T,1) is the PDSCH processing time for UE processing capability 1.

The successRAR is an octet aligned and is of fixed size as depicted in FIG. 3 (reproduced from 3GPP TS 38.321 V16.2.0 FIG. 6.2.3a-2).

As shown in Table 1 below (reproduced from 3GPP TS 38.211 V16.2.0 Table 6.3.2.1-1), five PUCCH formats are defined in NR, i.e., PUCCH formats 0 to 4. The UE transmits UCI in a PUCCH using PUCCH format 0 if the transmission is over 1 symbol or 2 symbols and the number of HARQ-ACK information bits with positive or negative SR (HARQ-ACK/SR bits) is 1 or 2. The UE transmits UCI in a PUCCH using PUCCH format 1 if the transmission is over 4 or more symbols and the number of HARQ-ACK/SR bits is 1 or 2. The UE transmits UCI in a PUCCH using PUCCH format 2 if the transmission is over 1 symbol or 2 symbols and the number of UCI bits is more than 2. The UE transmits UCI in a PUCCH using PUCCH format 3 if the transmission is over 4 or more symbols and the number of UCI bits is more than 2. The UE transmits UCI in a PUCCH using PUCCH format 4 if the transmission is over 4 or more symbols and the number of UCI bits is more than 2.

PUCCH formats 0 and 2 use one or two OFDM symbols while PUCCH formats 1, 3 and 4 can span from 4 to 14 symbols. Thus, PUCCH formats 0 and 2 are referred to as short PUCCH while PUCCH formats 1, 3 and 4 are referred to as long PUCCH.

TABLE 1

| | Length in | |
|---|---|---|
| PUCCH | OFDM symbols | Number |
| format | N_{symb}^{PUCCH} | of bits |
| 0 | 1-2 | ≤2 |
| 1 | 4-14 | ≤2 |
| 2 | 1-2 | >2 |
| 3 | 4-14 | >2 |
| 4 | 4-14 | >2 |

FIG. 4 illustrates an example of one and two symbol short PUCCH without FH, where FIG. 4(a) illustrates one symbol PUCCH and FIG. 4(b) illustrates two symbol PUCCH.

A PUCCH format 0 resource can be one or two OFDM symbols within a slot in time domain and one RB in frequency domain. UCI is used to select a cyclic shift of a computer-generated length 12 base sequence which is mapped to the RB. The starting symbol and the starting RB are configured by RRC. When 2 symbols are configured, the UCI bits are repeated in 2 consecutive symbols.

A PUCCH format 2 resource can be one or two OFDM symbols within a slot in time domain and one or more RB in frequency domain. UCI in PUCCH Format 2 is encoded with RM (Reed-Muller) codes (≤bit UCI+CRC) or Polar codes (>11 bit UCI+CRC) and scrambled. When 2 symbols are configured, UCI is encoded and mapped across two consecutive symbols.

Intra-slot frequency hopping (FH) may be enabled when 2 symbols are configured for PUCCH formats 0 and 2. If FH is enabled, the starting PRB in the second symbol is configured by RRC. Cyclic shift hopping is used when 2 symbols are configured such that different cyclic shifts are used in the 2 symbols.

FIG. 5 illustrates an example 14-symbol and 7-symbol long PUCCH with intra-slot FH enabled, wherein FIG. 5(a) illustrates 14 symbol PUCCH and FIG. 5(b) illustrates 7 symbol PUCCH.

FIG. 6 illustrates an example 14-symbol and 7-symbol long PUCCH with intra-slot FH disabled, wherein FIG. 6(a) illustrates 14 symbol PUCCH and FIG. 6(b) illustrates 7 symbol PUCCH.

A PUCCH format 1 resource is 4-14 symbols long and 1 PRB wide per hop. A computer-generated length 12 base sequence is modulated with UCI and weighted with time-domain OCC code. Frequency-hopping with one hop within the active UL BWP for the UE is supported and can be enabled/disabled by RRC. Base sequence hopping across hops is enabled for FH and across slots when no FH.

A PUCCH Format 3 resource is 4-14 symbols long and one or multiple PRB wide per hop. UCI in PUCCH Format 3 is encoded with RM (Reed-Muller) codes (11 bit UCI+CRC) or Polar codes (>11 bit UCI+CRC) and scrambled.

A PUCCH Format 4 resource is also 4-14 symbols long but 1 PRB wide per hop. It has a similar structure as PUCCH format 3 but can be used for multi-UE multiplexing.

For PUCCH formats 1, 3 or 4, a UE can be configured with a number of slots, N_{PUCCH}^{repeat}, for repetitions of a PUCCH transmission by respective nrofSlots which is defined in following IE:

| | |
|---|---|
| PUCCH-FormatConfig ::= | SEQUENCE { |
| interslotFrequencyHopping | ENUMERATED {enabled} |
| OPTIONAL, -- Need R | |
| additionalDMRS | ENUMERATED {true} |
| OPTIONAL, -- Need R | |
| maxCodeRate | PUCCH-MaxCodeRate |
| OPTIONAL, -- Need R | |
| nrofSlots | ENUMERATED {n2,n4,n8} |
| OPTIONAL, -- Need S | |
| pi2BPSK | ENUMERATED {enabled} |
| OPTIONAL, -- Need R | |
| simultaneousHARQ-ACK-CSI | ENUMERATED {true} |
| OPTIONAL -- Need R | |
| } | |

The nrofSlots is the number of slots with the same PUCCH F1, F3 or F4. When the field is absent, the UE applies the value n1. The field is not applicable for format 2.

For N_{PUCCH}^{repeat}>1, the UE repeats the PUCCH transmission with the UCI over N_{PUCCH}^{repeat} slots, a PUCCH transmission in each of the N_{PUCCH}^{repeat} slots has a same number of consecutive symbols, and a PUCCH transmission in each of the N_{PUCCH}^{repeat} slots has a same first symbol.

If the UE is configured to perform frequency hopping for PUCCH transmissions across different slots, then the UE performs frequency hopping per slot and the UE transmits the PUCCH starting from a first PRB in slots with even number and starting from the second PRB in slots with odd number. The slot indicated to the UE for the first PUCCH transmission has number 0 and each subsequent slot until the UE transmits the PUCCH in N_{PUCCH}^{repeat} slots is counted regardless of whether or not the UE transmits the PUCCH in the slot. The UE does not expect to be configured to perform frequency hopping for a PUCCH transmission within a slot

If the UE is not configured to perform frequency hopping for PUCCH transmissions across different slots and if the UE is configured to perform frequency hopping for PUCCH transmissions within a slot, the frequency hopping pattern between the first PRB and the second PRB is same within each slot.

FIG. 7 illustrates an example of PUCCH repetition in two slots, wherein FIG. 7(a) illustrates inter-slot FH enabled and FIG. 7(b) illustrates inter-slot FH disabled and intra-slot FH enabled.

The PUCCH resources used can be configured for the UE. In Rel-15, a UE can be configured with maximum four PUCCH resource sets where each PUCCH resource set consists of a number of PUCCH resources that can be used for a range of UCI sizes provided by configuration, including HARQ-ACK bits. The first set is only applicable for 1-2 UCI bits including HARQ-ACK information and can have maximum 32 PUCCH resources, while the other sets, if configured, are used for more than 2 UCI bits including HARQ-ACK and can have maximum 8 PUCCH resources.

| | |
|---|---|
| PUCCH-ResourceSet ::= | SEQUENCE { |
| pucch-ResourceSetId | PUCCH-ResourceSetId, |
| resourceList | SEQUENCE (SIZE |

(1..maxNrofPUCCH-ResourcesPerSet)) OF PUCCH-ResourceId,

| | |
|---|---|
| maxPayloadSize | INTEGER (4..256) |

OPTIONAL -- Need R
}
PUCCH-ResourceSetId ::=
INTEGER (0..maxNrofPUCCH-ResourceSets-1)

| | |
|---|---|
| maxNrofPUCCH-ResourceSets | INTEGER ::= 4 -- Maximum |

number of PUCCH Resource Sets

If a UE does not have dedicated PUCCH resource configuration provided by PUCCH-ResourceSet in PUCCH-Config, a PUCCH resource set is provided by pucch-ResourceCommon through an index to a row of Table 9.2.1-1 in 38.213 V16.2.0 for transmission of HARQ-ACK information on PUCCH in an initial UL BWP of N_{BWF}^{size} PRBs.

The PUCCH resource set includes sixteen resources, each corresponding to a PUCCH format, a first symbol, a duration, a PRB offset RB_{BWP}^{offset}, and a cyclic shift index set for a PUCCH transmission.

-- ASN1START
-- TAG-PUCCH-CONFIGCOMMON-START

| | |
|---|---|
| PUCCH-ConfigCommon ::= | SEQUENCE { |
| pucch-ResourceCommon | INTEGER (0..15) |

OPTIONAL, -- Cond InitialBWP-Only

| | |
|---|---|
| pucch-GroupHopping | ENUMERATED { neither, enable, |

disable },

| | |
|---|---|
| hoppingId | INTEGER (0..1023) |

OPTIONAL, -- Need R

| | |
|---|---|
| p0-nominal | INTEGER (−202..24) |

OPTIONAL, -- Need R
...
}
-- TAG-PUCCH-CONFIGCOMMON-STOP
-- ASN1STOP

The pucch-ResourceCommon parameter is an entry into a 16-row table where each row configures a set of cell-specific PUCCH resources/parameters. The UE uses those PUCCH resources until it is provided with a dedicated PUCCH-Config (e.g. during initial access) on the initial uplink BWP. Once the network provides a dedicated PUCCH-Config for that bandwidth part the UE applies that one instead of the one provided in this field.

NR Rel-16 introduces sub-slot based PUCCH transmission so that HARQ-ACK associated with different type of traffic can be multiplexed in a same UL slot, each transmitted in a different sub-slot. The sub-slot size can be higher layer configured to either 2 symbols or 7 symbols. For sub-slot configuration each with 2 symbols, there are 7 sub-slots in a slot. For sub-slot with 7 symbols, there are two sub-slots in a slot.

NR Rel-16 also includes HARQ ACK/NACK enhancement for URLLC. In NR Rel 16, a higher priority may be assigned to PDSCHs carrying URLLC (ultra-reliable low-latency) traffic and indicated in DCIs scheduling the PDSCHs. HARQ ACK/NACK information for PDSCHs with higher priority is transmitted separately from HARQ ACK/NACK information for other PDSCHs. This enables HARQ ACK/NACK for URLLC traffic to be transmitted early in different PUCCH resources and more reliably.

Furthermore, for NR Rel-16 at least one sub-slot configuration for PUCCH can be UE-specifically configured and multiple HARQ ACK/NACK transmissions per slot are possible. The sub-slot configuration supports periodicities of 2 symbols (i.e., seven 2-symbol PUCCH occasions per slot) and 7 symbols (i.e., two 7-symbol PUCCH occasions per slot). One of the reasons for introducing these sub-slot configurations in NR Rel-16 is to enable the possibility for multiple opportunities of HARQ ACK/NACK transmissions within a slot without needing to configure several PUCCH resources.

For example, in Rel-16, a UE running URLLC service may be configured with a possibility of receiving PDCCH in every second OFDM symbol, e.g., symbol 0, 2, 4, . . . , 12 and be configured with a PUCCH resource with sub-slot configuration seven 2-symbol sub-slots within a slot for HARQ-ACK transmission also in every second symbol, e.g. 1, 3, . . . , 13. For a Rel-16 UE configured with sub-slots for PUCCH transmission, the PDSCH-to-HARQ feedback timing indicator field in DCI indicates the timing offset in terms of sub-slots instead of slots.

NR also includes a CSI framework. In NR, a UE can be configured with multiple CSI reporting settings (each represented by a higher layer parameter CSI-ReportConfig with an associated identity ReportConfigID) and multiple CSI resource settings (each represented by a higher layer parameter CSI-ResourceConfig with an associated identity CSI-ResourceConfigId). Each CSI resource setting can contain multiple CSI resource sets (each represented by a higher layer parameter NZP-CSI-RS-ResourceSet with an associated identity NZP-CSI-RS-ResourceSetId for channel measurement or by a higher layer parameter CSI-IM-ResourceSet with an associated identity CSI-IM-ResourceSetId for interference measurement), and each NZP CSI-RS resource set for channel measurement can contain up to 8 NZP CSI-RS resources. For each CSI reporting setting, a UE feeds back a set of CSIs that may include one or more of a CRI (CSI-RS resource indicator), a RI, a PMI and a CQI per CW, depending on the configured report quantity.

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band.

Each CSI reporting setting contains at least the following information:
A CSI resource setting for channel measurement based on NZP CSI-RS resources (represented by a higher layer parameter resourcesForChannelMeasurement)
A CSI resource setting for interference measurement based on CSI-IM resources (represented by a higher layer parameter csi-IM-ResourcesForInterference)
Optionally, a CSI resource setting for interference measurement based on NZP CSI-RS resources (represented by a higher layer parameter nzp-CSI-RS-ResourcesForinterference)
Time-domain behavior, i.e. periodic, semi-persistent, or aperiodic reporting (represented by a higher layer parameter reportConfigType)
Frequency granularity, i.e. wideband or subband
CSI parameters to be reported such as RI, PMI, CQI, L1-RSRP/L1 SINR and CRI in the case that multiple NZP CSI-RS resources in a resource set is used for channel measurement (represented by a higher layer parameter report Quantity, such as ‘cri-RI-PMI-CQI’ ‘cri-RSRP’, or ‘ssb-Index-RSRP’)
Codebook types, i.e. type I or II if reported, and codebook subset restriction
Measurement restriction.

For periodic and semi-static CSI reporting, only one NZP CSI-RS resource set can be configured for channel measurement and one CSI-IM resource set for interference measurement.

For aperiodic CSI reporting, a CSI resource setting for channel measurement can contain more than one NZP CSI-RS resource set for channel measurement. If the CSI resource setting for channel measurement contains multiple NZP CSI-RS resource sets for aperiodic CSI report, only one NZP CSI-RS resource set can be selected and indicated to a UE.

For aperiodic CSI reporting, a list of trigger states is configured (given by the higher layer parameters CSI-AperiodicTriggerStateList). Each trigger state in CSI-AperiodicTriggerStateList contains a list of associated CSI-ReportConfigs indicating the Resource Set IDs for channel and optionally for interference. For a UE configured with the higher layer parameter CSI-AperiodicTriggerStateList, if a Resource Setting linked to a CSI-ReportConfig has multiple aperiodic resource sets, only one of the aperiodic CSI-RS resource sets from the Resource Setting is associated with the trigger state, and the UE is higher layer configured per trigger state per Resource Setting to select the one NZP CSI-RS resource set from the Resource Setting.

When more than one NZP CSI-RS resources are contained in the selected NZP CSI-RS resource set for channel measurement, a CSI-RS resource indicator (CRI) is reported by the UE to indicate to the gNB about the one selected NZP CSI-RS resource in the resource set, together with RI, PMI and CQI associated with the selected NZP CSI-RS resource. This type of CSI assumes that a PDSCH is transmitted from a single transmission point (TRP) and the CSI is also referred to as single TRP CSI.

In NR releases 15 and 16, an aperiodic measurement is triggered within DCI to indicate which Report Setting(s) and CSI-RS resource(s) for which to report CSI. In DCI format 0-1 and 0-2, a “CSI request” field is included for this purpose.

For DCI 0-1, the CSI request is 0, 1, 2, 3, 4, 5, or 6 bits determined by higher layer parameter reportTriggerSize. For DCI 0-2, the CSI request is 0, 1, 2, 3, 4, 5, or 6 bits determined by higher layer parameter reportTriggerSizeForDCI-Format0-2.

In CSI-MeasConfig IE, 2 parameters are defined to determine the number of bits for “CSI request” in DCI format 0-1 and DCI format 0-2 respectively: reportTriggerSize, and reportTriggerSizeForDCI-Format0-2.

With respect to the size of CSI request field in DCI (bits), the field reportTriggerSize applies to DCI format 0_1 and the field reportTriggerSizeForDCI-Format0-2 applies to DCI format 0_2.

Another parameter aperiodicTriggerStateList below in the CSI-MeasConfig IE is used to configure the UE with a list of aperiodic trigger states. Each codepoint of the DCI field “CSI request” is associated with one trigger state (which describes the MAC CE used for Aperiodic CSI Trigger State Subselection). Upon reception of the value associated with a trigger state, the UE will perform measurement of CSI-RS, CSI-IM and/or SSB (reference signals) and aperiodic reporting on L1 according to all entries in the associatedReportConfigInfoList for that trigger state.

The aperiodic TriggerStateList contains trigger states for dynamically selecting one or more aperiodic and semi-persistent reporting configurations and/or triggering one or more aperiodic CSI-RS resource sets for channel and/or interference measurement.

-- TAG-CSI-APERIODICTRIGGERSTATELIST-START

| | |
|---|---|
| CSI-AperiodicTriggerStateList ::= | SEQUENCE (SIZE (1..maxNrOfCSI- |

AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

(SIZE(1..maxNrofReportConfigPerAperiodicTrigger)) OF CSI-
AssociatedReportConfigInfo,
...
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI- |

RS-ResourceSetsPerConfig),

| | |
|---|---|
| qcl-info | SEQUENCE |

(SIZE(1..maxNrofAP-CSI-RS-ResourcesPerSet)) OF TCI-StateId
OPTIONAL -- Cond Aperiodic
},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM- |

```
ResourceSetsPerConfig)
OPTIONAL, -- Cond CSI-IM-ForInterference
  nzp-CSI-RS-ResourcesForInterference INTEGER (1..maxNrofNZP-CSI-RS-
ResourceSetsPerConfig)
OPTIONAL, -- Cond NZP-CSI-RS-ForInterference
  ...
}
-- TAG-CSI-APERIODICTRIGGERSTATELIST-STOP
-- ASN1STOP
```

There currently exist certain challenges. For example, in current NR specifications, aperiodic CSI feedback can only be carried via PUSCH. Furthermore, in current NR specifications, the aperiodic CSI feedback can only be trigged via uplink related DCI (i.e., DCI formats 0_1 and 0_2). However, this is not flexible in a scenario that is downlink heavy where the gNB would schedule the UE with PDSCH via downlink related DCI (i.e., DCI formats 1_1 and 1_2) more often than scheduling the UE with PUSCH via uplink related DCI. To improve network scheduling flexibility, it is beneficial to support triggering of aperiodic CSI via downlink related DCI. In this case, the aperiodic CSI will be carried on PUCCH.

### SUMMARY

As described above, certain challenges currently exist with reporting aperiodic channel state information (A-CSI) on a physical uplink control channel (PUCCH). For example, the existing NR specifications only supports triggered A-CSI report on physical uplink shared channel (PUSCH), using uplink transmission related downlink control information (DCI) formats, e.g., DCI format 0_1 and 0_2 or random access response (RAR). However, it is not clear how to provide PUCCH resource configuration for carrying A-CSI, if new radio (NR) is enhanced to support A-CSI report on PUCCH, triggered by downlink transmission related DCI formats, e.g., DCI format 1_1 and 1_2, or by downlink shared channel.

Default PUCCH resource sets will be used when the dedicated PUCCH resource sets are not available, and when A-CSI is scheduled in the same DCI or PDSCH as HARQ feedback, additional schemes are needed to select a different PUCCH resource and/or PUCCH resource set if the A-CSI and the HARQ-ACK are not expected to be multiplexed on the same PUCCH, especially when only short PUCCH format is selected.

Certain aspects of the present disclosure and their embodiments may provide solutions to these or other challenges. For example, particular embodiments facilitate A-CSI on PUCCH with respect to A-CSI triggering on PUCCH, A-CSI trigger state determination, PUCCH resource and resource set determination for A-CSI report, PUCCH repetition support for reliable A-CSI report transmission, and common PUCCH resource and PUCCH resource set configuration before dedicated PUCCH resource is available.

For particular embodiments, A-CSI may be transmitted on PUCCH without depending on uplink (UL) grant for data if A-CSI only transmission on PUSCH is not expected. Repetition may be supported on PUCCH, which provides more robust A-CSI transmission, which is beneficial given A-CSI on PUSCH cannot be repeated in current specification and the A-CSI is identified as bottle neck channel in NR.

According to some embodiments, a method for obtaining CSI comprises: a) generating a DCI to trigger an A-CSI reporting via PUCCH; and b) initiating the A-CSI reporting by sending the DCI to a terminal device.

According to some embodiments, a method for obtaining CSI comprises: a) receiving from a node a DCI to trigger an A-CSI reporting via PUCCH; b) carrying out the A-CSI reporting; and c) sending an A-CSI report to the node.

According to some embodiments, a node for obtaining CSI comprises: a storage device configured to store a computer program comprising computer instructions; and a processor coupled to the storage device and configured to execute the computer instructions to perform the method as described above.

According to some embodiments, a terminal device comprises: a processor; memory in communication with the processor; and instructions stored in the memory and operable, when executed by the processor, to cause the apparatus to perform the method according to any of the terminal device methods described herein.

According to some embodiments, a computer program product for obtaining CSI is embodied in a computer readable storage medium and comprising computer instructions for performing the method as described above.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a schematic diagram illustrating new radio (NR(time-domain structure with 15 kHz subcarrier spacing;

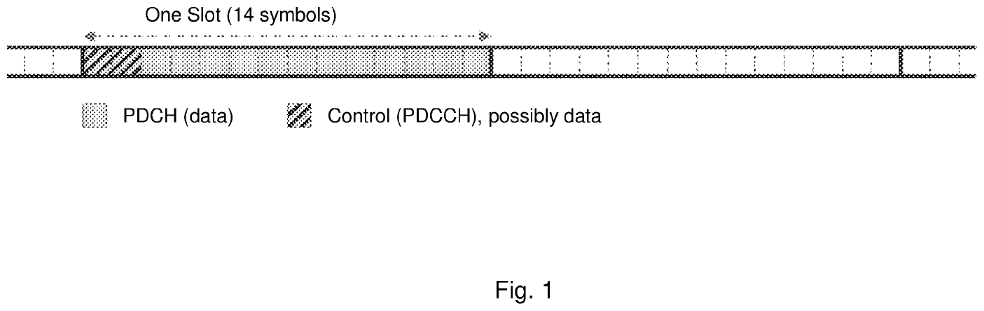

FIG. 2 is a schematic diagram illustrating a basic NR physical time-frequency resource grid;

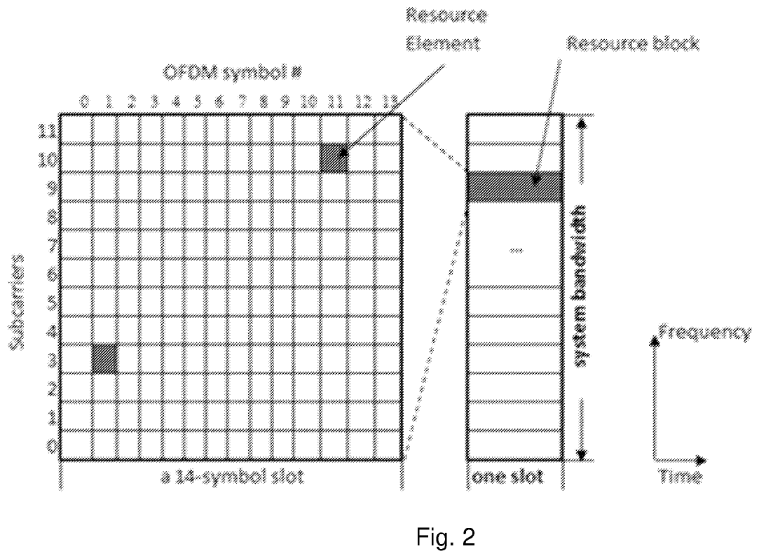

FIG. 3 is a schematic diagram illustrating an octet aligned and having fixed size;

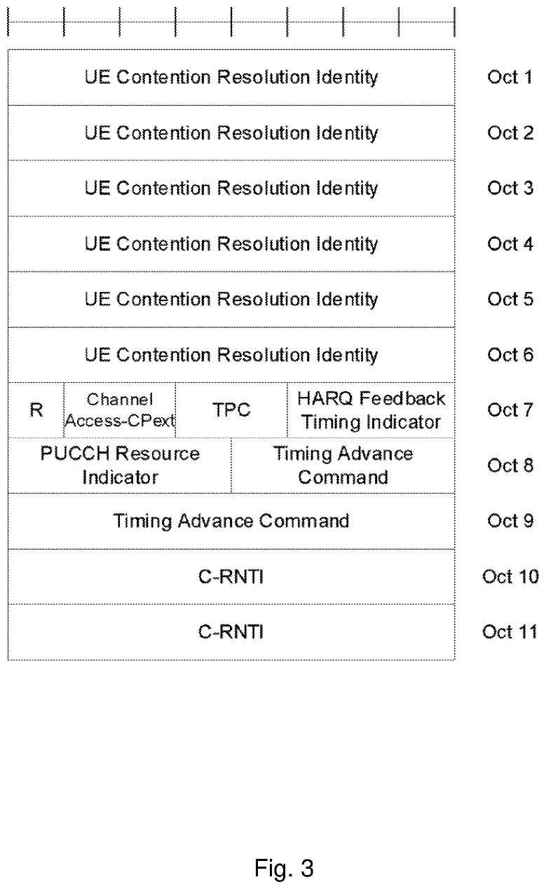

FIGS. 4(a) and 4(b) are graphs illustrating an example short PUCCH without frequency hopping (FH) in the cases with one symbol physical uplink control channel (PUCCH) and with two symbol PUCCH, respectively;

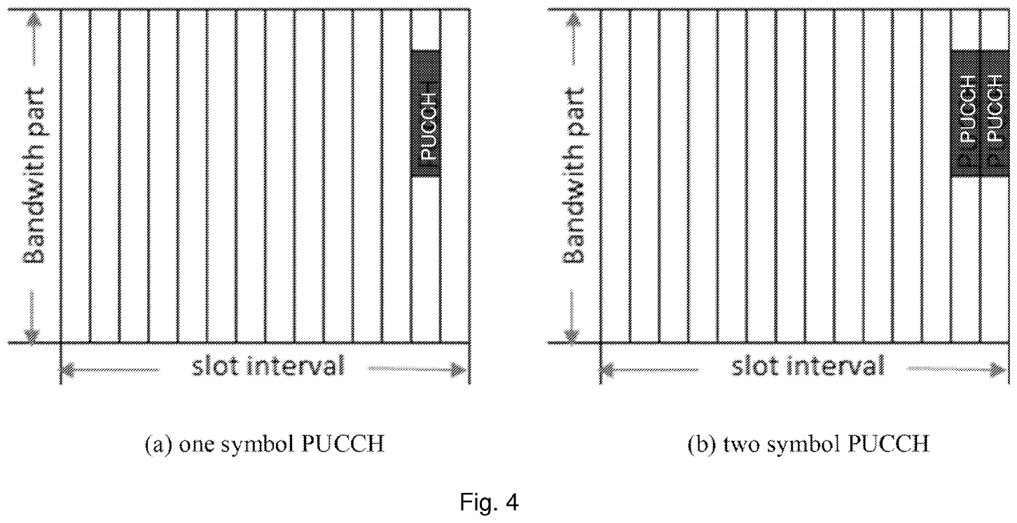

FIGS. 5(a) and 5(b) are graphs illustrating an example long PUCCH with intra-slot FH enabled in the cases with 14 symbol PUCCH and 7 symbol PUCCH, respectively;

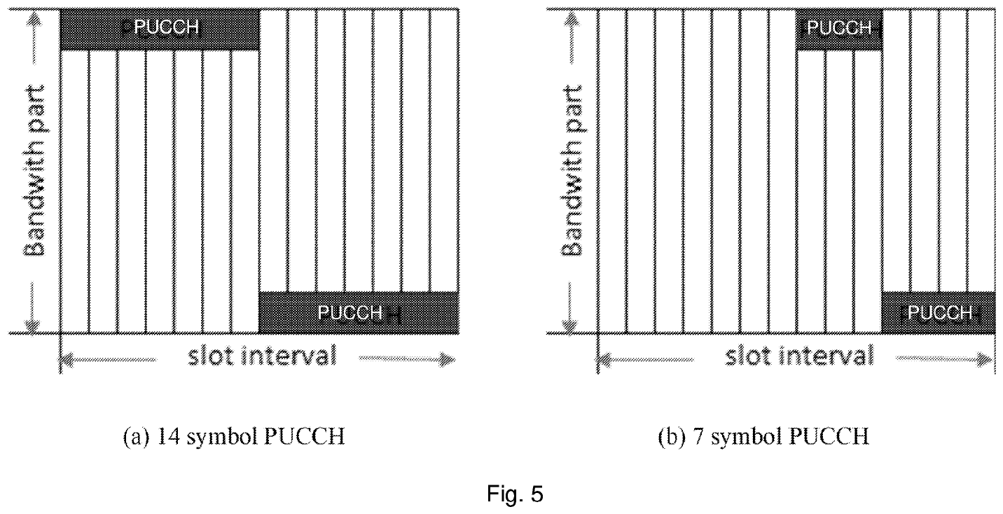

FIGS. 6(a) and 6(b) are graphs illustrating an example long PUCCH with intra-slot FH disabled in the cases with 14 symbol PUCCH and with 7 symbol PUCCH, respectively;

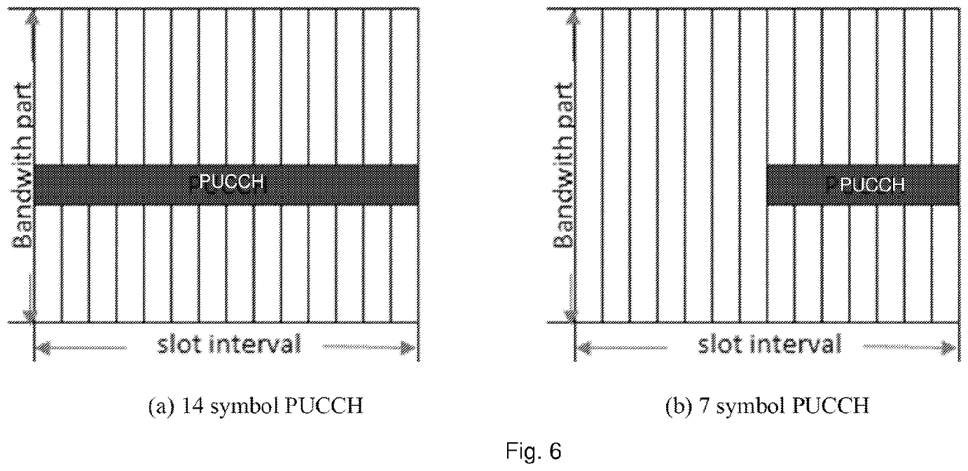

FIGS. 7(a) and 7(b) are graphs illustrating an example of PUCCH repetition in two slots in the cases with inter-slot FH enabled and with inter-slot FH disabled and intra-slot FH enabled, respectively;

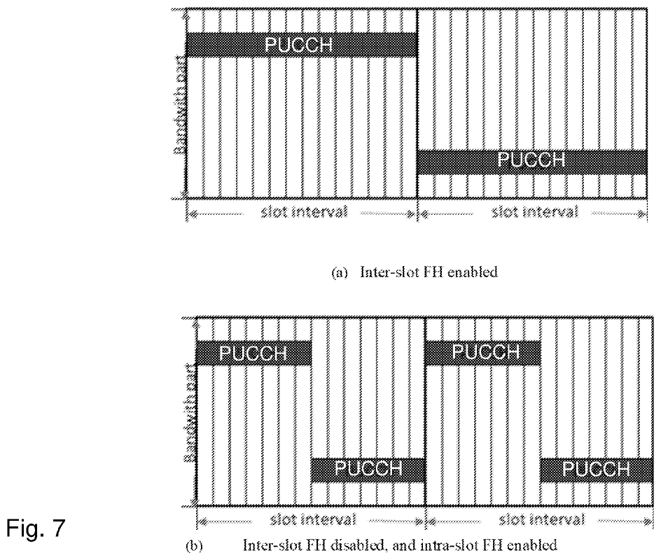

FIG. 8 schematically illustrates triggering statistical CSI based on multiple CSI reference resources for interference measurement;

FIG. 9 schematically illustrates CSI reporting with NZP CSI-RS always present in reference resource;

FIG. 10 schematically illustrates CSI reporting with a configured reporting update periodicity;

FIG. 11 is a flow chart illustrating a method for obtaining CSI according to some embodiments;

FIG. 12 is a block diagram illustrating a node according to some embodiments;

FIG. 13 is a flow chart illustrating a method in a terminal device for obtaining CSI according to some embodiments;

FIG. 14 is a block diagram illustrating a terminal device according to some embodiments; and

FIG. 15 is flow chart illustrating another method in a terminal device for obtaining CSI according to some embodiments.

### DETAILED DESCRIPTION

As described above, certain challenges currently exist with reporting aperiodic channel state information (A-CSI) on a physical uplink control channel (PUCCH). For example, the existing NR specifications only supports triggered A-CSI report on physical uplink shared channel (PUSCH), using uplink transmission related downlink control information (DCI) formats, e.g., DCI format 0_1 and 0_2 or random access response (RAR). However, it is not clear how to provide PUCCH resource configuration for carrying A-CSI, if new radio (NR) is enhanced to support A-CSI report on PUCCH, triggered by downlink transmission related DCI formats, e.g., DCI format 1_1 and 1_2, or by downlink shared channel.

Certain aspects of the present disclosure and their embodiments may provide solutions to these or other challenges. In some embodiments, a CSI request field is included in downlink related DCI this may be used to trigger aperiodic CSI reports on PUCCH. Furthermore, some embodiments may reuse the existing PUCCH resource indication field in downlink related DCI to indicate the PUCCH resource for aperiodic CSI feedback. Depending on if the downlink related DCI carries a downlink grant for physical downlink shared channel (PDSCH) and/or a CSI request, the PUCCH resource indication field may be interpreted differently according to particular embodiments.

In some embodiments, the aperiodic CSI and the hybrid automatic repeat request acknowledgement (HARQ-ACK) corresponding to the PDSCH being scheduled by the downlink related DCI are multiplexed and sent on the same PUCCH resource. To address the cases where the PDSCH processing time and the processing time for aperiodic CSI are different, in some embodiments the aperiodic CSI and HARQ-ACK corresponding to the PDSCH being scheduled by the downlink related DCI are transmitted in different slots.

Some embodiments use uplink DCI to indicate whether A-CSI is on PUCCH or PUSCH, on support of specific PUCCH format, i.e. format 2, 3, 4, and on A-CSI on PUCCH handling when colliding with other CSI in the same slot.

In the following detailed description, numerous specific details such as logic implementations, types and interrelationships of system components, etc. are set forth to provide a more thorough understanding of particular embodiments. It should be appreciated by one skilled in the art that the particular embodiments may be practiced without such specific details. In other instances, control structures, circuits and instruction sequences have not been shown in detail to not obscure the present disclosure. Those of ordinary skill in the art, with the included descriptions, will be able to implement appropriate functionality without undue experimentation.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed texts and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

In the following detailed description and claims, the terms “coupled” and “connected”, along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

An electronic device stores and transmits (internally and/or with other electronic devices) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For example, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical interfaces to establish connections (to transmit and/or receive code and/or data using propagating signals) with other electronic devices. One or more parts of an embodiment of the present disclosure may be implemented using different combinations of software, firmware, and/or hardware.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Some embodiments include triggering A-CSI in DL DCI formats. To enable A-CSI trigger in DL DCI formats, some embodiments include an optional field in the relevant DCI formats, e.g., DCI format 1_1 and 1_2.

For DCI format 1_x (e.g., 1_1, 1_2), one of the following options may be applied. In a first option, an explicit field is provided in DCI format 1_x for triggering A-CSI report. For example, the A “CSI request” field may include the following examples. An integer N_(TS,max) provides the largest number of bits ‘CSI request’ field may take. To keep DCI size low, a small N_(TS,max) value may be used, for example, N_(TS,max)=1. On the other hand, if DCI size is not of concern, then a larger N_(TS,max) value may be used to indicate more possibilities of CSI report, for example, N_(TS,max)=6.

The CSI request N_TS bits may be determined by a higher layer parameter, where N_TS=0, or 1, or . . . , or N_(TS,max). The higher layer parameter may be reportTriggerSizeDCI1-x (or, equivalently, reportTriggerSizeDCI1-x-r17 when attaching ‘r17’ to indicate the release of the specification).

In some embodiments, the higher layer parameter reportTriggerSizeDCI1-x is provided via a field of IE CSI-MeasConfig, as illustrated below. Note that the size of the CSI request field may be independently configured per DL related DCI format (e.g., reportTriggerSizeDCI-1-1-r17 for DCI format 1_1 and reportTriggerSizeDCI-1-2-r17 for DCI format 1_2 independently configured within CSI-MeasConfig).

### CSI-MeasConfig Information Element

| | |
|---|---|
| -- ASN1START | |
| -- TAG-CSI-MEASCONFIG-START | |
| CSI-MeasConfig ::= | SEQUENCE { |
| ..., | |
| [[ | |
| reportTriggerSizeDCI1-x-r17 | INTEGER (0..N_{TS,max}) |
| OPTIONAL -- Need R | |
| ]] | |

In a second option, the A-CSI report may be implicitly triggered by DCI format 1_x. When the A-CSI is implicitly triggered, then the ‘CSI request’ field may be assigned a default value of predefined length N_{TS,0}. The typical range for N_{TS,0} is, 0≤N_{TS,0}≤6. As an example, N_{TS,0} is assigned a fixed value smaller than or equal to 6 (bits), e.g., N_{TS,0}=1 and ‘CSI request’ is understood as a 1-bit sequence of value ‘1’.

In one example, the A-CSI report is triggered if the DCI format 1_x contains a field “CSI PUCCH resource indicator” with field size N_{PUCCH,CSI}>1. In this case, the PUCCH resource is provided for carrying A-CSI (potentially carrying other information as well). If this field is present in DCI format 1_x, then the UE determines that A-CSI is triggered.

In another example, the A-CSI report is triggered if the field size of “PUCCH resource indicator” in DCI format 1_x is larger than that provided for existing functionality. For example, for DCI format 1_1, “PUCCH resource indicator” has size 3-bit for existing functionality. Thus, if “PUCCH resource indicator” is provided with size larger than 3 bits, then the UE determines that A-CSI is triggered.

For example, for DCI format 1_2, “PUCCH resource indicator” has size 0 or 1 or 2 or 3 bits determined by the higher layer parameter numberOfBitsForPUCCH-ResourceIndicatorForDCI-Format1-2 for existing functionality. Thus, if “PUCCH resource indicator” is provided with size larger than numberOfBitsForPUCCH-ResourceIndicatorForDCI-Format1-2 bits, then the UE determines that A-CSI is triggered.

In some embodiments, whether a CSI request field is present or not in a DL DCI may be configured by higher layer.

In some embodiments, whether A-CSI on PUCCH can be triggered by DCI depends on the resource characteristics of the PDCCH carrying the DCI. For example, it depends on the CORESET the corresponding PDCCH is mapped to, and/or depends on the search space the PDCCH is mapped to; and/or the monitoring span the PDCCH is mapped to.

For example, the CSI request field in DCI is configured per control resource set (CORESET) or per search space set so that DCI in different CORESETs or search space sets may be configured differently.

In another example, A-CSI on PUCCH may be triggered by DCI if the corresponding PDCCH is mapped to UE-specific search space, and it cannot be triggered by DCI if the corresponding PDCCH is mapped to common search.

In another example, A-CSI on PUCCH may be triggered by the DCI when the corresponding PDCCH is mapped to the first monitoring span in a slot. On the other hand, A-CSI on PUCCH is not to be triggered by the DCI when the corresponding PDCCH is mapped to the last monitoring span in a slot.

In yet another embodiment, triggering A-CSI on PUCCH in DL DCI is a UE capability and it can only be configured if it is supported by the UE indicated in its capability signaling.

In particular embodiments, A-CSI on PUCCH may be triggered by a DCI associated with certain RNTI(s), but not other RNTI(s). For example, A-CSI on PUCCH can be triggered by DL DCI with its CRC scrambled by C-RNTI or MCS-C-RNTI. On the other hand, A-CSI may not be triggered when the CRC of the DL DCI is scrambled with a CS-RNTI.

In another example, A-CSI on PUCCH may be triggered by DL DCI associated with UE-specific RNTI, but not group-common RNTI, or cell-common RNTI.

In particular embodiments, A-CSI on PUCCH is triggered by a DL DCI with its CRC scrambled by a specific RNTI, e.g., ACSI-C-RNTI.

Some embodiments include a new aperiodic CSI reporting type to be triggered via DL related DCI. In particular embodiments, a new CSI reporting configuration type is included in CSI-ReportConfig information element for aperiodic CSI to be reported on PUCCH. An example of the new aperiodic CSI reporting type (e.g., aperiodicOnPUCCH-r17) is shown below. When a DL related DCI triggers an aperiodic CSI, the trigger is limited to report configurations of this new type of CSI report configs. For example, when a DL related DCI with format 1_1 triggers an aperiodic CSI, then the aperiodic CSI shall be of type aperiodicOnPUCCH-r17.

The aperiodicOnPUCCH-r17 may be optional. In some embodiments, if the field reportConfigType-r17 (which contains aperiodicOnPUCCH-r17 in the example below) is present, the UE shall ignore the field reportQuantity (without suffix).

In one example embodiment, the aperiodicOnPUCCH-r17 may contain one or more other fields such as the following: reportSlotConfig-r17, which provides the periodicity and slot offset of the PUCCH resource when the PUCCH resource occurs with a periodicity; and pucch-CSI-ResourceList-r17, which provides the list of PUCCH resources to be used for aperiodic CSI feedback for different bandwidth parts (BWPs).

### CSI-ReportConfig Information Element

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |
| reportSlotConfig | ENUMERATED {s15, s110, |

s120, s140, s180, s1160, s1320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE |

```
(1..maxNrofUL-Allocations)) OF INTEGER(0..32)
      }
    },
    ...,
    [[
```

| | |
|---|---|
| reportConfigType-r17 | SEQUENCE { |
| aperiodicOnPUCCH-r17 | SEQUENCE { |
| reportSlotConfig-r17 | CSI- |

ReportPeriodicityAndOffset,

| | |
|---|---|
| pucch-CSI-ResourceList-r17 | SEQUENCE (SIZE |

(1..maxNrofBWPs)) OF PUCCH-CSI-Resource
}

| | |
|---|---|
| } | OPTIONAL, - |

- Need R
]]
}
-- TAG-CSI-REPORTCONFIG-STOP
-- ASN1STOP

In another example embodiment, a single PUCCH resource is specifically configured for aperiodic CSI to be transmitted on PUCCH in the CSI-ReportConfig information element in TS 38.331. An example of the modified CSI-ReportConfig information element is shown below. As shown in the example below, a PUCCH resource (e.g., ‘pucch-Resource’) with a resource identifier ‘PUCCH-ResourceId’ is configured as part of the new CSI reporting configuration type. In some embodiments, the PUCCH resource provided in the new CSI reporting configuration type can be periodic. If the PUCCH resource is periodic, then reportSlotConfig-r17, which provides the periodicity and slot offset of the PUCCH resource, may be configured as part of the new CSI reporting configuration type. The benefit of configuring the PUCCH resource separately for A-CSI triggered by DL related DCI is that the PUCCH resource can be better configured for CSI transmission.

### CSI-ReportConfig Information Element

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI- |

ReportPeriodicityAndoffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |
| reportSlotConfig | CSI- |

ReportPeriodicityAndoffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |
| reportSlotConfig | ENUMERATED {s15, |

s110, s120, s140, s180, s1160, s1320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE |

```
(1..maxNrofUL-Allocations)) OF INTEGER(0..32)
      }
    },
    ...,
    [[
```

| | |
|---|---|
| reportConfigType-r17 | SEQUENCE { |
| aperiodicOnPUCCH-r17 | SEQUENCE { |
| pucch-Resource | PUCCH-ResourceId |
| reportSlotConfig-r17 | CSI- |

ReportPeriodicityAndOffset,
}

| | |
|---|---|
| } | OPTIONAL, - |

- Need R
]]
}
-- TAG-CSI-REPORTCONFIG-STOP
-- ASN1STOP

In another example embodiment,

The CSI report configuration provides a set of PUCCH resources (e.g., a list of 2\hat{ }n entries) for triggered A-CSI on PUCCH. Correspondingly, n bits in the DCI provides the index to the set of PUCCH resources. In the illustrated configuration below, 2\hat{ }n is provided by parameter ‘maxNrofPUCCH-ACSI’.

Furthermore, CSI report configuration can provide a set of slot offsets for transmitting the PUCCH (e.g., a list of 2\hat{ }m entries) for triggered A-CSI. Correspondingly, m bits in the DCI provides the index to the set of slot offsets. In the illustrated configuration below, 2\hat{ }m is provided by parameter ‘maxNrofPUCCH-Allocations’. In the preferred example, the slot offset provides the slot for PUCCH transmission relative to the PDCCH slot timing, where the PDCCH contains the triggering DCI.

An example of the CSI report configuration is illustrated below.

| CSI-ReportConfig ::= | SEQUENCE { | |
|---|---|---|
| reportConfigId | | CSI-ReportConfigId, |
| ..., | | |
| [[ | | |

| | |
|---|---|
| reportConfigType-r17 | SEQUENCE { |
| aperiodicOnPUCCH-r17 | SEQUENCE { |
| pucch-ResourceList-r17 | SEQUENCE (SIZE |

(1..maxNrofPUCCH-ACSI)) OF PUCCH-ResourceId,

| | |
|---|---|
| pucch-reportSlotOffsetList-r17 | SEQUENCE (SIZE |

(1..maxNrofPUCCH-Allocations)) OF INTEGER(0..32),

| | |
|---|---|
| } | |
| } | OPTIONAL, - |

- Need R

]]

Some embodiments include determination of trigger state. Similar to the UL DCI format triggered A-CSI report, the trigger state of A-CSI is initiated via the information provided by the DL DCI. Either the existing CSI-AperiodicTriggerStateList or a new, separate, aperiodic CSI trigger state list (called “ACSI-on-PUCCH-AperiodicTriggerStateList” below) may be used.

When the existing A-CSI trigger state list (i.e., CSI-AperiodicTriggerStateList) is used, when ‘CSI request’ field is absent from the DL DCI, or when all the bits of ‘CSI request’ field in the DL DCI are set to zero, no CSI is requested, and when the number of configured CSI triggering states in CSI-AperiodicTriggerStateList is greater than 2^{N}^{_{TS}}−1, where N_{TS} is the number of bits of CSI request field (implicitly or explicitly provided), the UE receives a subselection indication, as described in clause 6.1.3.13 of TS 38.321, used to map up to 2^{N}^{_{TS}}−1 trigger states to the codepoints of the ‘CSI request’ implicitly or explicitly provided by the DL DCI. In some examples, the MAC CE for subselection is different from the subselection MAC CE for A-CSI on PUSCH, e.g. using a different LCD or by using the reserved bit to indicate if the MAC CE relate to A-CSI on PUCCH or on PUSCH.

When the number of CSI triggering states in CSI-AperiodicTriggerStateList is less than or equal to 2^{N}^{_{TS}}−1, the CSI request field in DCI directly indicates the triggering state.

When the existing aperiodic CSI trigger state list is used for DL related DCI, some rules may be defined when it comes to which CSI reporting config types are to be associated with an aperiodic CSI trigger state. A few embodiments that define such rules are given below:

In particular embodiments, an existing aperiodic trigger state is associated with one or more CSI reporting configurations which may have report configuration types of either ‘aperiodicOnPUCCH-r17’ or ‘aperiodic’ (note that report configuration type ‘aperiodic’ refers to aperiodic CSI on PUSCH). In some embodiments, a rule defines that if the existing aperiodic trigger state is triggered by a DL related DCI, then only CSI report with configuration type ‘aperiodicOnPUCCH-r17’ is computed and reported by the UE. On the other hand, if the existing aperiodic trigger state is triggered by an UL related DCI, then only CSI report with configuration type ‘aperiodic’ is computed and reported by the UE.

In particular embodiments, a subset of the existing aperiodic trigger states are associated with one or more CSI reporting configurations that have a report configuration type of ‘aperiodicOnPUCCH-r17’. The subset of existing aperiodic trigger states may be triggered by a DL related DCI because an aperiodic CSI triggered by DL related DCI is reported on PUCCH. Similarly, a second subset of the existing aperiodic trigger states may associated with one or more CSI reporting configurations that have report configuration type of ‘aperiodic’. The second subset of existing aperiodic trigger states can be triggered by a UL related DCI because an aperiodic CSI triggered by UL related DCI is reported on PUSCH.

When a new aperiodic CSI trigger state list (e.g., ACSI-on-PUCCH-AperiodicTriggerStateList) is defined for A-CSI on PUCCH, a new, separate number of A-CSI trigger states may be configured, as compared to that of CSI-AperiodicTriggerStateList. For example, a smaller number of A-CSI trigger states may be configured such that a small number of bits, e.g., 1 or 2 bits, may be used for a A-CSI request field in DL DCI, as compared to the number of bits for the “CSI request” field in UL DCI. If a new aperiodic CSI trigger state is defined for A-CSI on PUCCH, then the new aperiodic trigger states are associated with one or more CSI reporting configurations that have a report configuration type of aperiodicOnPUCCH-r17′.

In some embodiments, if CSI request is triggered, and “ZP CSI-RS trigger” is present (i.e., with field size >1) in the same DL DCI, then the aperiodic ZP-CSI-RS is applied in CSI calculation, e.g., for interference measurement.

In some embodiments, if CSI request is triggered by the DL DCI, then the DMRS indicated by the same DCI is used for generating channel measurement.

In some embodiments, the triggered A-CSI on PUCCH is a statistical CSI, e.g., statistical CQI such as mean, variance and/or percentile CQI to capture interference variations. The triggered A-CSI on PUCCH in such embodiment is determined based on multiple CSI reference resources for interference measurements.

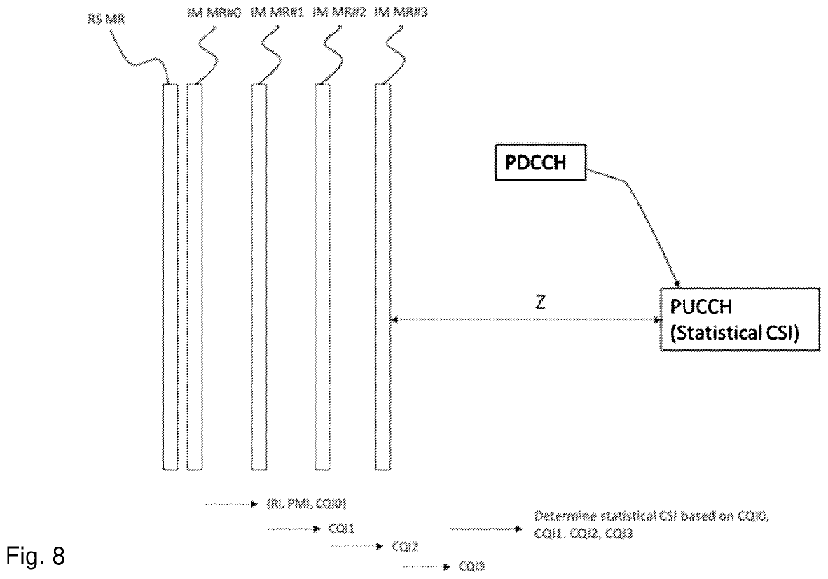

FIG. 8 illustrates where 4 CSI reference resources for interference measurement meets a CSI processing limitation Z where the UE determines a CQI value per CSI reference resource for interference measurement. In some examples, statistical A-CSI on PUCCH is enabled by configuring the trigger state with an enabling field, e.g., statisticalCsiEnabled. In other examples, statistical A-CSI on PUCCH is enabled by a MAC CE, e.g., in a new MAC CE for sub-selection of CSI trigger states for A-CSI on PUCCH.

Some embodiments enable A-CSI multiplexing with HARQ A/N in the same PUCCH resource. In these embodiments, for A-CSI triggered by a DL DCI, the same PUCCH resource is used for both the A-CSI and the HARQ-ACK associated with a PDSCH scheduled by the same DCI. To be able to apply a same time offset for both the HARQ ACK-and the A-CSI, in some embodiments, only periodic or semi-persistent NZP CSI-RS and/or CSI-IM are used for A-CSI trigger in DL DCI. In addition, one or more CSI report configurations associated with periodic or semi-persistent NZP CSI-RS and CSI-IM may be configured. One or more A-CSI triggering states for A-CSI on PUCCH may be configured separately from existing A-CSI triggering states for A-CSI on PUSCH.

Furthermore, for a single A-CSI triggering state for A-CSI on PUCCH, a UE updates the CSI periodically before receiving any A-CSI trigger. When A-CSI trigger in a DL DCI is received, the UE is ready to report the CSI right after the PDCCH decoding. In this way, the A-CSI processing is not the limiting factor in determining the time offset of the PUCCH resource. In some embodiments, the UE may begin calculating the A-CSI when the periodic or semi-persistent NZP CSI-RS for channel measurement occurs, completing the calculation after a predetermined number of slots, such that if the UE is triggered to report the CSI in a slot after the calculation is complete, the CSI report is updated. If the report is in a slot prior to when the calculation is complete, the report is not updated, in which case the UE may provide a previously calculated CSI report. In some such embodiments, the CSI reference resource may be defined by the slot in which the NZP CSI-RS occurs.

Because the UE begins and ends calculation of a CSI report according to the NZP CSI-RS periodicity and a fixed delay, a benefit of this embodiment is that the UE need not constantly calculate CSI, thereby reducing its computational complexity and/or power consumption for CSI reporting. In some embodiments, the benefit may be reflected by specifying that a unit of CSI processing capability (CPU′) is used by the UE starting with the slot containing the NZP CSI-RS and ending the predetermined number of slots after the NZP CSI-RS. In some such embodiments, the UE is capable of calculating multiple CSI reports simultaneously, and the predetermined number of slots between the NZP CSI-RS and the slot where the UE completes the report calculation is determined by if the UE is calculating a single or multiple CSI reports. In some such embodiments, the predetermined number of slots is 4 or 5 when the UE is simultaneously calculating a single or multiple CSI reports, respectively.

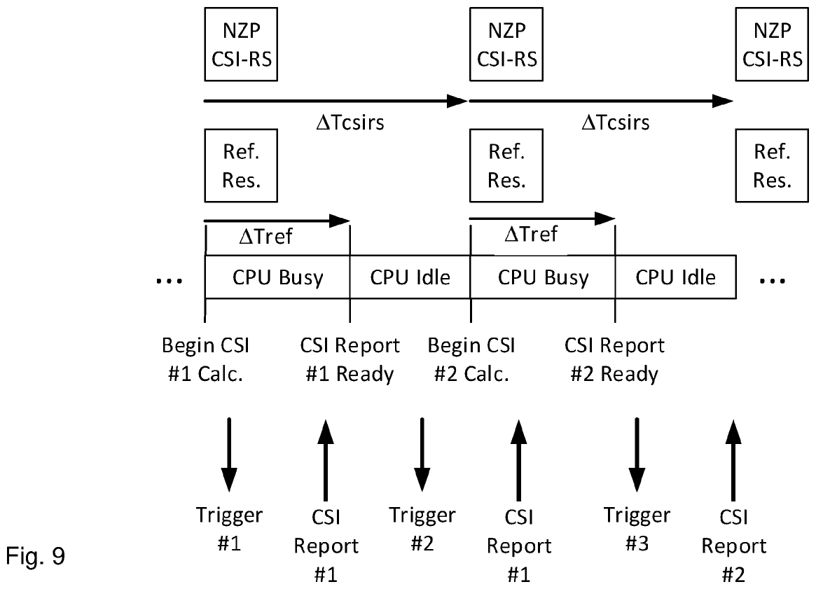

FIG. 9 schematically illustrates CSI reporting with NZP CSI-RS always present in reference resource. NZP CSI-RS is configured with a periodicity of ΔTcsirs. The UE begins measuring the NZP CSI-RS and calculating CSI at the beginning of each NZP CSI-RS. The CSI computation is complete, and an updated CSI report is ready a predetermined delay (ΔTref) after the beginning of the CSI-RS resource.

The CSI processing unit is assumed to be busy from the beginning of the CSI-RS resource until the time the report is ready but is idle otherwise. The CSI report is updated if the trigger occurs after the CSI report is ready. For example, the CSI report following trigger #1 contains CSI report #1 because the trigger is after when CSI report #1 is ready. However, the CSI report after trigger #2 also contains CSI report #1 because trigger #2 is prior to when CSI report #2 is ready.

A disadvantage of calculating a CSI report only from a slot containing an NZP CSI-RS is that this precludes computing CSI for a later slot that is closer to the time the CSI report is triggered. For example, the UE could interpolate the NZP CSI-RS to form a more up to date channel measurement closer to the CSI report, which may therefore be more accurate. In such cases, it is still necessary to define when an updated CSI report can be available and the slot containing the reference resource on which the report is calculated. Some embodiments define periodically recurring times in which updated CSI reports are available.

In particular embodiments, the UE is configured with a first periodicity that identifies periodically recurring time instants in which the UE should provide an updated CSI report. The reference resource on which the report is calculated a predetermined length of time prior to the time instant in which the UE should provide the updated CSI report. The NZP CSI-RS used for the CSI report for channel measurement is transmitted with a second periodicity. The UE is triggered to transmit each CSI report independently. If the slot for which the report is triggered is later than the most recent time instant in which an updated CSI report is available, it provides the updated CSI report; otherwise, the UE provides a CSI report that is not updated.

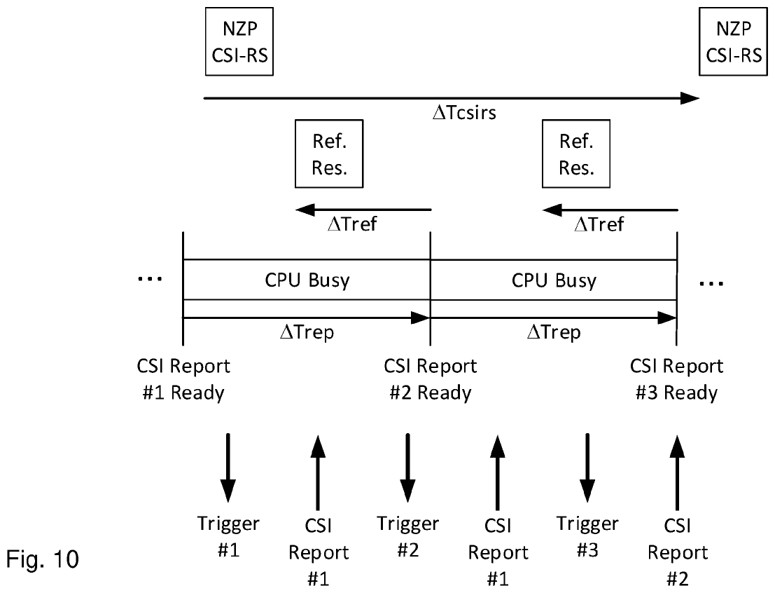

Through this use of periodically recurring CSI report update time instants, the CSI reports can be updated more frequently than the rate at which the NZP CSI-RS is transmitted, allowing more accurate CSI while not increasing CSI-RS overhead. On the other hand, the UE may need to continuously update the channel measurement used for the CSI calculations, which can require additional effort. Therefore, in some embodiments a unit of CSI processing capability (CPU′) is used by the UE for each NZP CSI-RS for which it is configured to provide an aperiodic CSI report, wherein the CPU is assumed to be used in all slots. An example is illustrated in FIG. 10.

FIG. 10 schematically illustrates CSI reporting with a configured reporting update periodicity. NZP CSI-RS is again configured with a periodicity of ΔTcsirs. The UE measures the NZP CSI-RS when it occurs and may interpolate the CSI-RS measurement such that it corresponds to the time at which the reference resource occurs. The reference resource precedes the time at which an updated CSI report is ready by length of time ΔTref. The UE may compute a CSI report at any time after the CSI-RS measurement is available but must complete by the time the next updated report is to be available. The CSI processing unit is assumed to be busy during the entirety of the CSI update report period ΔTrep. As in FIG. 9, the CSI report is updated if the trigger occurs after the CSI report is ready. For example, the CSI report following trigger #1 contains CSI report #1 because the trigger is after when CSI report #1 is ready. However, the CSI report after trigger #2 also contains CSI report #1 because trigger #2 is prior to when CSI report #2 is ready.

In particular embodiments, updated aperiodic CSI is calculated prior to a CSI report trigger and on periodically transmitted CSI-RS. The reference resource may be defined according to one of two alternatives: always in the same slot as the CSI-RS, or it precedes a periodically recurring time in which the CSI is to be updated. More specifically, a method in a UE of providing aperiodic CSI reports comprises receiving signaling configuring the UE with an NZP CSI-RS that is transmitted with a first periodicity. The UE calculates an updated CSI report that is available at a time T2 corresponding to a reference resource occurring at a time T1, according to one of where the reference resource occurs at the first periodicity and the CSI-RS is transmitted at time T1, and where the time T1 occurs a predetermined length of time ΔT prior to T2 and T2 is one of a plurality of time instants occurring at a second periodicity. The UE receives a trigger to report CSI at a time T, and provides the CSI report corresponding to time T1 when the time T is greater than or equal to T2, and providing a CSI report corresponding to a time T0 that is prior to T0 when the time T is less than T2.

A bit field of one bit in the DL DCI may be used to either trigger or not trigger an A-CSI. The one-bit bit field may be a new bit field or may reuse an existing bit field. In another embodiment, it may be implicitly indicated. For example, when A-CSI triggering with DL DCI is configured, part of the CRC parity bits of DCI format 0_1 or DCI format 0_2 can be scrambled with both the corresponding RNTI x_{rnti,0}, x_{rnti,1}, . . . , x_{rnti,15} and an A-CSI mask x_{ACSI,0}, x_{ACSI,1}, . . . , x_{ACSI,15} as indicated in Table 2. Let {bₖ, k=0,1, . . . K−1} be the coded DCI bits with CRC, where K=A+L and A is the DCI payload size and L=24 is the number of CRC bits. The sequence of bits c₀, c₁, c₂, c₃, . . . , c_{K-1} after scrambling is given by:

cₖ=bₖ for k=0,1,2, . . . ,A+7

cₖ=(bₖ+x_{rnti,k-A}+x_{ACSI,k-A})mod 2 for k=A+8,A+9,A+10, . . . ,A+23.

TABLE 2
A-CSI mask

| A-CSI | A-CSI mask |
|---|---|
| trigger | <x_{ACSI,0}, x_{ACSI,1}, . . . , x_{ACSI,15}> |
| Disabled | <0, 0, 0, 0, 0, 0, 0, 0, 0, 0, 0, 0, 0, 0, 0, 0> |
| Enabled | <0, 0, 0, 0, 0, 0, 0, 0, 0, 0, 0, 0, 0, 0, 0, 1> |

The examples above may assume that the triggering DCI is a typical DL DCI that schedules one PDSCH transmission. However, the DL DCI formats 1_1 and 1_2 can be used for other purposes as well.

For example, DCI formats 1_1 and 1_2 are used for activation or release of DL SPS configurations, and the associated RNTI is CS-RNTI. In some embodiments, DCI formats 1_1/1_2 used for activation of DL SPS can be used to trigger A-CSI as well, using the embodiments described herein.

As another example, DCI formats 1_1/1_2 used for activation DL SPS may not be used to trigger A-CSI. The DCI fields used for A-CSI triggering (e.g., for indicating k′ or PUCCH resource for A-CSI) may then be used for validation of the activation DCI, to improve the false alarm likelihood of the activation DCI. For example, such fields are set to all ‘0’ (or all ‘1’).

In another example, DCI formats 1_1/1_2 used for release of DL SPS can be used to trigger A-CSI as well, using the embodiments described herein. It should be noted that in this case, the HARQ-ACK timing k is with reference to the scheduling PDCCH, thus the timing of the A-CSI may need to be defined with reference to PDCCH, so that the same timing is applied regardless of the presence/absence of a scheduled PDSCH.

In some embodiments, DCI formats 1_1/1_2 used for release of DL SPS may not be used to trigger A-CSI. The DCI fields included for A-CSI triggering (e.g., for indicating k′ or PUCCH resource for A-CSI) may then be used for validation of the release DCI, to improve the false alarm likelihood of the release DCI. For example, such fields are set to all ‘0’ (or all ‘1’).

In another example, the DL DCI triggers A-CSI without scheduling PDSCH. Thus, DCI fields related to PDSCH scheduling are not necessary, and these fields can be omitted or used for purposes other than PDSCH scheduling.

In yet another example, the DL DCI triggers A-CSI and another UCI type without scheduling PDSCH. One option is to use the DL DCI to trigger A-CSI and HARQ-ACK transmission without scheduling PDSCH. In this case, the HARQ-ACK is not for acknowledgement of PDSCH dynamically scheduled by the same DCI. Instead, the HARQ-ACK is for previously scheduled, but not acknowledged, PDSCH(s), where the PDSCH can be for initial transmission or retransmission of dynamically scheduled PDSCH, or initial transmission or retransmission of DL SPS PDSCH. For example, the DCI may be sent to trigger both A-CSI and one-shot HARQ-ACK.

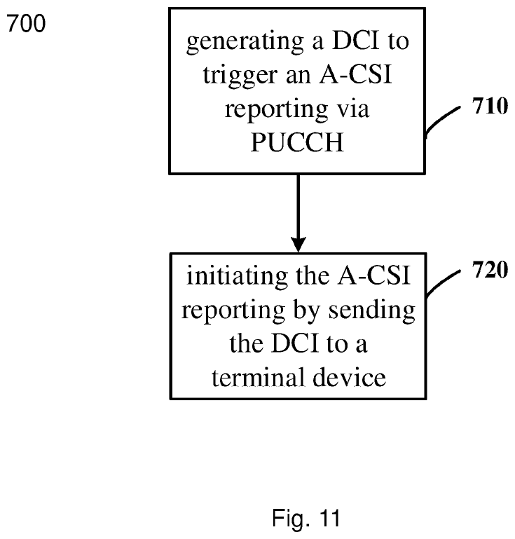

FIG. 11 is a flow chart illustrating a method 700 for obtaining CSI according to some embodiments. As illustrated in FIG. 11, the flowchart comprises the following steps performed, e.g., at a base station network node such as NodeB, eNB, gNB, etc.:

At step 710 the network node generates a DCI to trigger an A-CSI reporting via PUCCH. At step 720, the network node initiates the A-CSI reporting by sending the DCI to a terminal device.

The DCI may be generated according to any of the embodiments and examples described herein. For example, in particular embodiments the DCI comprises one of a format 1_1 DCI and a format 1_2 DCI. The DCI may include a field for indicating a request for A-CSI reporting (e.g., explicit field of length between 1 and 6 bits). In some embodiments the field may be an implicit field. For example, the field for indicating a request for A-CSI reporting may comprises a PUCCH resource indicator. In some embodiments, the field is assigned to a default value indicating the request for A-CSI reporting.

In particular embodiments, the field for indicating a request for A-CSI reporting comprises a field with a bit-length above a threshold value. For example, PUCCH resource indicator may have a longer length than a traditional PUCCH resource indicator.

In particular embodiments, characteristics of a physical downlink control channel (PDCCH) carrying the DCI indicates that the DCI comprises a request for A-CSI reporting, control resource set (CORESET) or a search space set.

In particular embodiments, a radio network temporary identifier (RNTI) associated with the DCI indicates that the DCI comprises a request for A-CSI reporting (e.g., some types of RNTI indicate a request and others do not).

In particular embodiments, the DCI includes an indication of one or more CSI trigger states and/or an indication of PUCCH resources to be used for the A-CSI reporting.

In particular embodiments, hybrid automatic repeat request (HARD) feedback is to be multiplexed on the PUCCH with the A-CSI reporting.

In particular embodiments, the A-CSI reporting is used for obtaining statistic CSI.

In particular embodiments, the DCI is configured to carry out activation or release of DL SPS configurations.

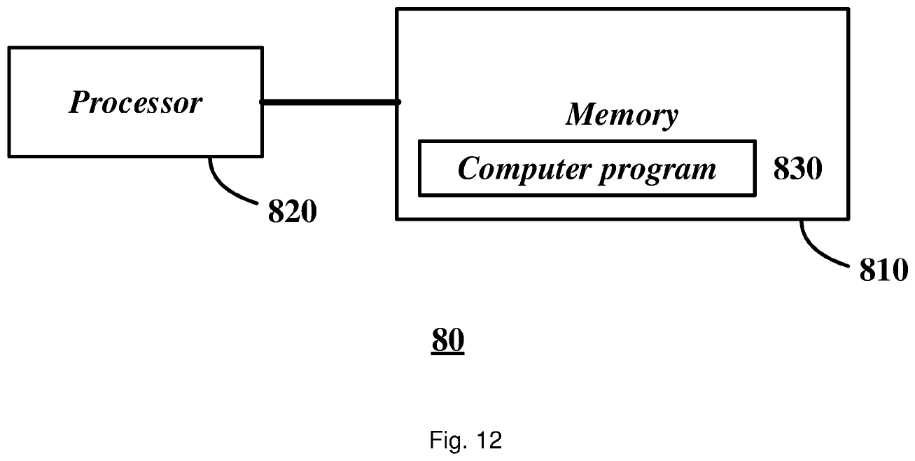

FIG. 12 is a block diagram illustrating a node according to some embodiments. With reference to FIG. 12, the node 80 comprises memory 810 and a processor 820 coupled to the memory 810. The memory 810 is configured to store a computer program 830 comprising computer instructions. The processor 820 is configured to execute the computer instructions to perform some or all of the method steps as shown in FIG. 11.

In this embodiment, the node may be a base station, an eNodeB or gNodeB.

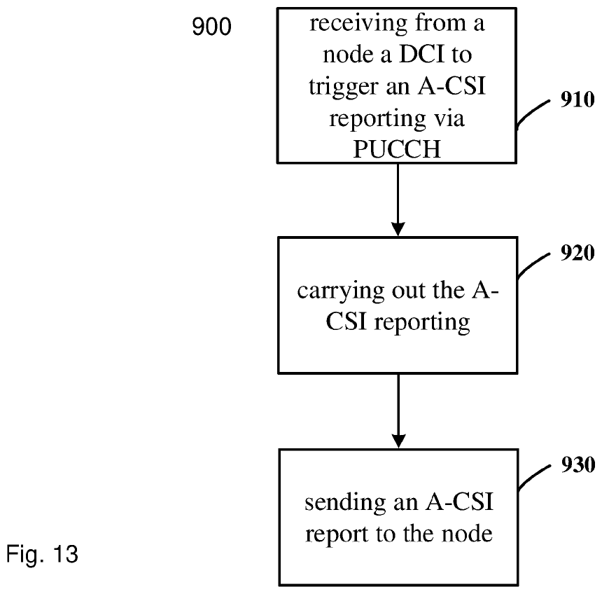

FIG. 13 is a flow chart illustrating a method in a terminal device for obtaining CSI according to some embodiments. As shown in FIG. 13, the flowchart comprises the following steps performed at terminal device:

At step 910 the terminal device (e.g., UE) receives from a node a DCI to trigger an A-CSI reporting via PUCCH. At step 920 the terminal device carries out the A-CSI reporting. At step 930 the terminal device sends an A-CSI report to the node. The terminal device may receive the DCI and carry out the CSI reporting according to any of the embodiments and examples described herein. Examples of the DCI are described in more detail with respect to FIG. 11.

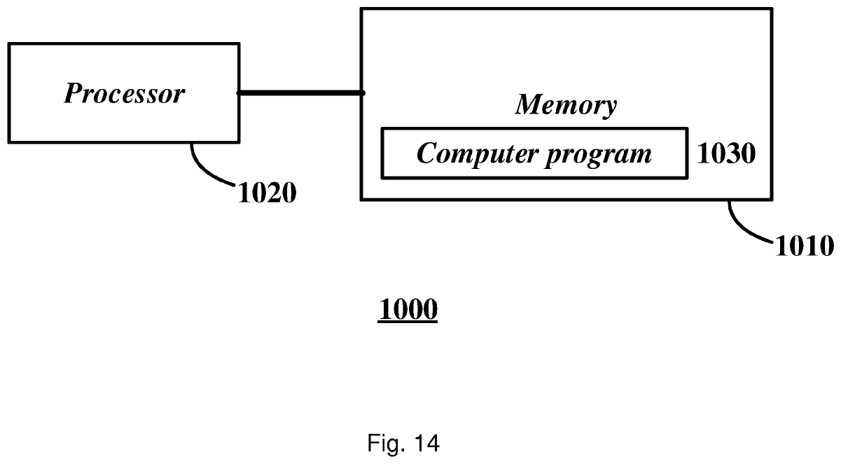

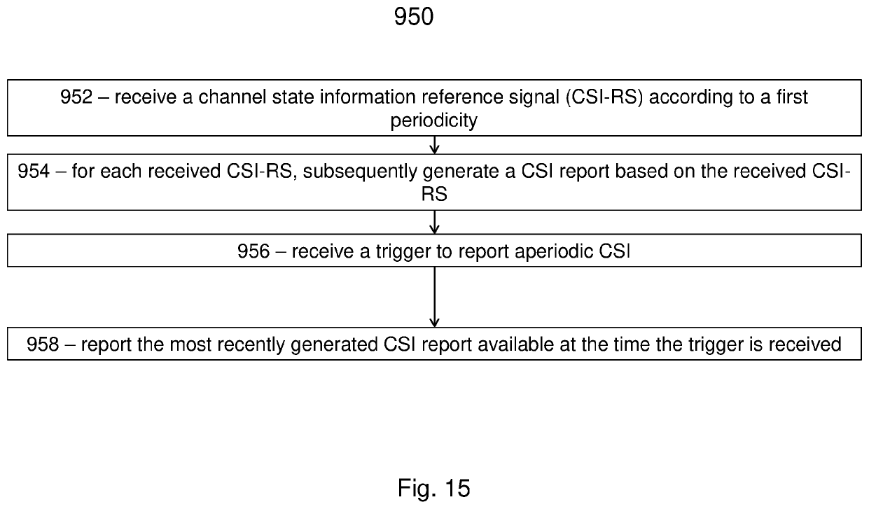

FIG. 14 is a block diagram illustrating a terminal device according to some embodiments. With reference to FIG. 14, the terminal device 1000 comprises memory 1010 and a processor 1020 coupled to the memory 1010. The memory 1010 is configured to store a computer program 1030 comprising computer instructions. The processor 1020 is configured to execute the computer instructions to perform some or all of the method steps as shown in FIGS. 13 and 15.

FIG. 15 is a flow chart illustrating another method in a terminal device for obtaining CSI according to some embodiments. As shown in FIG. 15, the flowchart comprises the following steps performed at terminal device:

At step 952 the terminal device (e.g., UE) receive a channel state information reference signal (CSI-RS) according to a first periodicity (e.g., see FIGS. 9 and 10).

At step 954 the terminal device, for each received CSI-RS, subsequently generate a CSI report based on the received CSI-RS. As illustrated in FIGS. 9 and 10, there is an amount of time that passes between measurement of the reference signal and the availability of the measurement report.

At step 956, the terminal device receives a trigger to report aperiodic CSI. The trigger may comprise any of the DCI triggers described herein. Examples of the DCI are described in more detail with respect to FIG. 11.

At step 958, the terminal device reports the most recently generated CSI report available at the time the trigger is received. As illustrated in FIGS. 9 and 10, if the terminal device has performed a measurement, but has not finished generating an updated CSI report at the time the trigger is received, then the terminal device reports a previously generated report. The terminal device may carry out the CSI reporting according to any of the embodiments and examples described herein (e.g., via PUCCH).

It should be noted that the aforesaid embodiments are illustrative instead of restricting, substitute embodiments may be designed by those skilled in the art without departing from the scope of the claims enclosed. The wordings such as “include”, “including”, “comprise” and “comprising” do not exclude elements or steps which are present but not listed in the description and the claims. It also shall be noted that as used herein and in the appended claims, the singular forms “a”, “an”, and “the” include plural referents unless the context clearly dictates otherwise. Embodiments can be achieved by means of hardware including several different elements or by means of a suitably programmed computer. In the unit claims that list several means, several ones among these means can be specifically embodied in the same hardware item. The use of such words as first, second, third does not represent any order, which can be simply explained as names.

Some portions of the foregoing detailed description have been presented in terms of algorithms and symbolic representations of transactions on data bits within a computer memory. These algorithmic descriptions and representations are ways used by those skilled in the signal processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more signal processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed signal processing components and fixed hardwired circuit components.

In the foregoing detailed description, embodiments of the present disclosure have been described with reference to specific example embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method implemented by a network node in a communication network for obtaining channel state information (CSI), the method comprising:
generating a downlink control information (DCI) to trigger an aperiodic CSI (A-CSI) reporting via a physical uplink control channel (PUCCH); and
transmitting the DCI to a terminal device to initiate A-CSI reporting on the PUCCH.

2.-11. (canceled)

12. A network node in a communication network, comprising:
a processor; and
a memory communicatively coupled to the processor and adapted to store instructions which, when executed by the processor, cause the network node to:
generate a downlink control information (DCI) to trigger an aperiodic CSI (A-CSI) reporting via a physical uplink control channel (PUCCH); and
transmit the DCI to a terminal device to initiate A-CSI reporting on the PUCCH.

13. The network node of claim 12, wherein the DCI comprises one of a format 1_1 DCI and a format 1_2 DCI.

14. The network node of claim 12, wherein the DCI includes a field for indicating a request for A-CSI reporting.

15. The network node of claim 14, wherein the field for indicating a request for A-CSI reporting comprises a PUCCH resource indicator, wherein the PUCCH resource indicator indicates a PUCCH resource in which A-CSI report on PUCCH is transmitted.

16. The network node of claim 14, wherein the field for indicating a request for A-CSI reporting comprises a field with a bit-length above a threshold value.

17. The network node of claim 12, wherein characteristics of a physical downlink control channel (PDCCH) carrying the DCI indicates that the DCI comprises a request for A-CSI reporting.

18. The network node of claim 17, wherein the characteristics of the PDCCH comprise one or more of a control resource set (CORESET) and a search space set.

19. The network node of claim 12, wherein a radio network temporary identifier (RNTI) associated with the DCI indicates that the DCI comprises a request for A-CSI reporting.

20. The network node of claim 12, wherein the DCI includes an indication of one or more CSI trigger states, wherein the one or more CSI trigger states contains at least one associated CSI report configuration which is explicitly configured with a reporting type of A-CSI on PUCCH.

21. The network node of claim 12, wherein the DCI includes an indication PUCCH resources to be used for the A-CSI reporting.

22. The network node of claim 12, wherein hybrid automatic repeat request (HARQ) feedback is to be multiplexed on the PUCCH with the A-CSI reporting.

23. A method implemented by a terminal device in a communication network for providing channel state information (CSI), the method comprising:
receiving a downlink control information (DCI) to trigger an aperiodic CSI (A-CSI) reporting via a physical uplink control channel (PUCCH);
obtaining a CSI report; and
transmitting the CSI report to a network node on the PUCCH.

24.-33. (canceled)

34. A terminal device in a communication network for providing channel state information (CSI), comprising:
a processor; and
a memory communicatively coupled to the processor and adapted to store instructions which, when executed by the processor, cause the user equipment (UE) to:
receive a downlink control information (DCI) to trigger an aperiodic CSI (A-CSI) reporting via a physical uplink control channel (PUCCH);
obtain a CSI report; and
transmit the CSI report to a network node on the PUCCH.

35. The terminal device of claim 34, wherein the DCI comprises one of a format 1_1 DCI and a format 1_2 DCI.

36. The terminal device of claim 34, wherein the DCI includes a field for indicating a request for A-CSI reporting.

37. The terminal device of claim 36, wherein the field for indicating a request for A-CSI reporting comprises a PUCCH resource indicator, wherein the PUCCH resource indicator indicates a PUCCH resource in which A-CSI report on PUCCH is transmitted.

38. The terminal device of claim 36, wherein the field for indicating a request for A-CSI reporting comprises a field with a bit-length above a threshold value.

39. The terminal device of claim 34, wherein characteristics of a physical downlink control channel (PDCCH) carrying the DCI indicates that the DCI comprises a request for A-CSI reporting.

40. The terminal device of claim 39, wherein the characteristics of the PDCCH comprise one or more of a control resource set (CORESET) and a search space set.

41. The terminal device of claim 34, wherein a radio network temporary identifier (RNTI) associated with the DCI indicates that the DCI comprises a request for A-CSI reporting.

42. The terminal device of claim 34, wherein the DCI includes an indication of one or more CSI trigger states, wherein the one or more CSI trigger states contains at least one associated CSI report configuration which is explicitly configured with a reporting type of A-CSI on PUCCH.

43. The terminal device of claim 34, wherein the DCI includes an indication PUCCH resources to be used for the A-CSI reporting.

44. The terminal device of claim 34, wherein hybrid automatic repeat request (HARQ) feedback is to be multiplexed on the PUCCH with the A-CSI reporting.

45. A method implemented by a terminal device in a communication network for providing channel state information (CSI), the method comprising:
receiving a channel state information reference signal (CSI-RS) according to a first periodicity;
for each received CSI-RS, subsequently generating a CSI report based on the received CSI-RS;
receiving a trigger to report aperiodic CSI; and
reporting the most recently generated CSI report available at the time the trigger is received.

46. The method of claim 45, wherein reporting the most recently generated CSI report comprises transmitting the most recently generated CSI report on a physical uplink control channel (PUCCH).
